(19) United States
(12) Patent Application Publication
(10) Pub. No.: US 2016/0163528 A1
(43) Pub. Date: Jun. 9, 2016

(54) INTERFACE FOR AN ATMOSPHERIC PRESSURE ION SOURCE IN A MASS SPECTROMETER

(71) Applicant: Bruker Daltonics, Inc., Billerica, MA (US)

(72) Inventors: Maurizio SPLENDORE, Walnut Creek, CA (US); Stephen ZANON, Campbell, CA (US)

(21) Appl. No.: 14/558,801

(22) Filed: Dec. 3, 2014

(51) Int. Cl. H01J 49/24; H01J 49/16

(52) U.S. Cl. CPC H01J 49/24; H01J 49/165

(57) ABSTRACT

The invention relates to a mass spectrometer having an ion source region at substantially atmospheric pressure in which ions are formed from a liquid sample. The mass spectrometer further has an interface for transmitting the formed ions from the ion source region into a vacuum region which is held at a pressure level substantially below the atmospheric pressure and where the formed ions are further processed. The interface comprises a wall dividing the ion source region and the vacuum region and has a central orifice formed therein for letting pass gaseous and particulate matter from the ion source region into the vacuum region following the pressure gradient, wherein the central orifice is surrounded at least section-wise by a plurality of lateral orifices.

### BACKGROUND OF THE INVENTION

1. Field of the Invention

The invention relates to devices for transporting ions from an atmospheric pressure ion (API) source into a vacuum region of a mass spectrometer.

2. Description of the Related Art

Inlet systems for API interfaces are known, for example, from liquid chromatograph-mass spectrometer (LC/MS) arrangements to transfer an eluent from a high performance liquid chromatograph (HPLC) into the first vacuum region of a mass spectrometer after having been ionized at atmospheric pressure. Capillaries as well as orifices can be used in such inlet systems. It is immediately apparent that, in addition to the pumping speed in the first vacuum region, the diameter of the orifice and the diameter as well as the length of the capillary will determine the throughput of ions and residual gas as well as the pressure in the first vacuum region.

Capillary interfaces are generally believed to have the benefit of improving heat transfer to the flowing gas, which can result in a better desolvation process, that is, the evaporation of droplets entrained in the gas and the concomitant additional release of ions of interest. However, charged particles like ions and droplets can be lost during the transmission through the capillary when they impinge on the capillary walls, thereby degrading the number of ions available for the mass spectrometric analysis (sensitivity). A practitioner in the field will acknowledge that this effect becomes more serious with rising capillary length.

Orifices, on the other hand, are generally believed to cause less loss of charged particles since they do not have walls on which the charged particles could impinge. However, when the diameter of an interface orifice is increased to a certain extent, heat transfer to the passing particulate and gaseous matter will decline with consequent lack of desolvation, that is, the sensitivity will be degraded for a different reason.

U.S. Pat. No. 6,803,565 A to Smith et al. discloses a multi-capillary inlet to focus ions and other charged particles generated at or near atmospheric pressure into a relatively low pressure region with the aim of increasing conductance of ions and other charged particles. The multi-capillary inlet is juxtaposed between an ion source and the interior of an instrument maintained at near atmospheric pressure. Such arrangement is stated to improve the ion transmission in particular between an electrospray ionization source and the first vacuum stage of a mass spectrometer.

U.S. Pat. No. 6,914,240 B2 to Giles et al. describes a mass spectrometer having an ion source with a plurality of atmospheric pressure sample ionizers mounted in a front face thereof. Each sample ionizer extends into a corresponding sample region and the tip of each sample ionizer is mounted at right-angles to a corresponding one of a plurality of entrance cones each having an entrance orifice therein. Each entrance cone in turn opens into an inlet channel having first and second parts. The two parts of the inlet channel are separated by an electrical gate. The inlet channels corresponding to each entrance cone all merge into a common exit channel to a mass spectrometer. It is stated that, by appropriate operation of the gates dividing the inlet channels, rapid switching between the samples that are analyzed in the mass analyzer can be achieved.

U.S. Pat. No. 6,914,243 B2 to Sheehan et al. presents a multiple-aperture laminated structure placed at the interface of two pressure regions. Electric fields geometries and strengths across the laminated structure and diameters of the apertures are stated to optimize the transfer of the ions from the higher pressure region into the lower pressure region while reducing the gas-load on the lower pressure region.

U.S. Pat. No. 7,462,822 B2 to Gebhardt et al. discloses methods and devices for the transport of ions generated in gases near atmospheric pressure into the vacuum system of a mass spectrometer. Instead of the single capillary customary in commercial instruments, a multichannel plate with hundreds of thousands of very short and narrow capillaries, whose total gas throughput is stated to not being higher than that of a normal single capillary, is used. The large-area take-up of ions in the gas flow is further stated to greatly increase the transfer yield.

U.S. Pat. No. 8,309,916 B2 to Wouters et al. shows an ion transfer tube for a mass spectrometer comprising a tube member having an inlet end and an outlet end; and at least one bore extending through the tube member from the inlet end to the outlet end, the at least one bore having a non-circular cross section.

In view of the foregoing, there is a need to provide an interface between an API source and a vacuum region of a mass spectrometer that allows for increased throughput of ions, thereby increasing the sensitivity of the analysis, largely without concomitant reduction of droplet desolvation efficiency.

### SUMMARY OF THE INVENTION

The invention relates, in a first aspect, to a mass spectrometer having an ion source region at substantially atmospheric pressure in which ions are formed from a liquid sample, and further having an interface for transmitting the formed ions from the ion source region into a vacuum region which is held at a pressure level substantially below the atmospheric pressure and where the formed ions are further processed, wherein the interface comprises a wall (or equivalent boundary) dividing the ion source region and the vacuum region and having a central orifice formed therein for letting pass gaseous and particulate matter from the ion source region into the vacuum region following the pressure gradient, the central orifice being surrounded at least section-wise by a plurality of lateral orifices.

In various embodiments, the central orifice is of substantially circular shape.

In various embodiments, a portion of the wall has conical shape, the apex of the cone points in the direction of the ion source region, and the central orifice is located at the apex.

In various embodiments, the wall is made of conductive material, such as sheet metal. In some embodiments, an electric potential is applied to the wall to attract the ions formed in the ion source region.

In various embodiments, a traversable area of each lateral orifice substantially equals, or is greater than, a traversable area of the central orifice.

In various embodiments, the lateral orifices each have arcuate, elongate shape. In some embodiments, a curved (inner) contour of the lateral orifices aligns with a curved (outer) contour of the central orifice.

In various embodiments, the lateral orifices are interconnected with the central orifice via narrow, elongate openings (slits).

In various embodiments, the plurality of lateral orifices extends over at least half an angular circumference of the central orifice.

In various embodiments, a pressure in the vacuum region is at most half of that in the ion source region, such as about 53,700 Pascal, for example, if the atmospheric pressure is about 101,325 Pascal.

In various embodiments, an RF ion guide is located in the vacuum region opposite the plurality of orifices to receive a stream of gas and ions emanating therefrom. In some embodiments, the RF ion guide is an RF ion funnel aligned with its wide end toward the plurality of orifices.

In various embodiments, the ion source region contains a spray source by means of which the liquid sample is nebulized therein and that is aligned such that ions and gas emanating from a spray cone are sampled through the orifices into the vacuum region. In some embodiments, the spray source is an electrospray probe. In further embodiments, the spray source receives an eluent of one of a liquid chromatograph and an apparatus for capillary electrophoresis as liquid sample.

The invention further relates, in a second aspect, to a mass spectrometer having an ion source region at substantially atmospheric pressure in which ions are formed from a liquid sample, and further having an interface for transmitting the formed ions from the ion source region into a vacuum region which is held at a pressure level substantially below the atmospheric pressure and where the formed ions are further processed, wherein the interface comprises a wall dividing the ion source region and the vacuum region and having an orifice of irregular shape formed therein for letting pass gaseous and particulate matter from the ion source region into the vacuum region following the pressure gradient, the orifice comprising a central portion which is fluidly connected to a plurality of distinct peripheral portions.

In various embodiments, the fluid connections between the central portion and the plurality of peripheral portions may be oriented substantially orthogonally to an extension of the plurality of peripheral portions.

In various other embodiments, the fluid connections between the central portion and the plurality of peripheral portions may be oriented substantially in line with the plurality of peripheral portions.

A curved contour of the plurality of peripheral portions may generally align with a curved contour of the central portion.

### BRIEF DESCRIPTION OF THE DRAWINGS

The invention can be better understood by referring to the following figures. The components in the figures are not necessarily to scale, emphasis instead being placed upon illustrating the principles of the invention (often schematically). In the figures, like reference numerals designate corresponding parts throughout the different views.

FIG. 1 shows a schematic assembly of the steps an analytical sample may pass before the final mass spectrometric measurement;

FIG. 2 shows a schematic view of an interface arrangement practicable for the present invention;

FIG. 3 shows the effect of free jet expansion at an atmospheric pressure-sub-atmospheric pressure interface;

FIG. 4 shows a front view of an interface arrangement according to principles of the invention;

FIGS. 5A-C show different embodiments of interface arrangements according to principles of the invention; and

FIG. 6 shows a sketch of an experimental test set-up.

### DETAILED DESCRIPTION

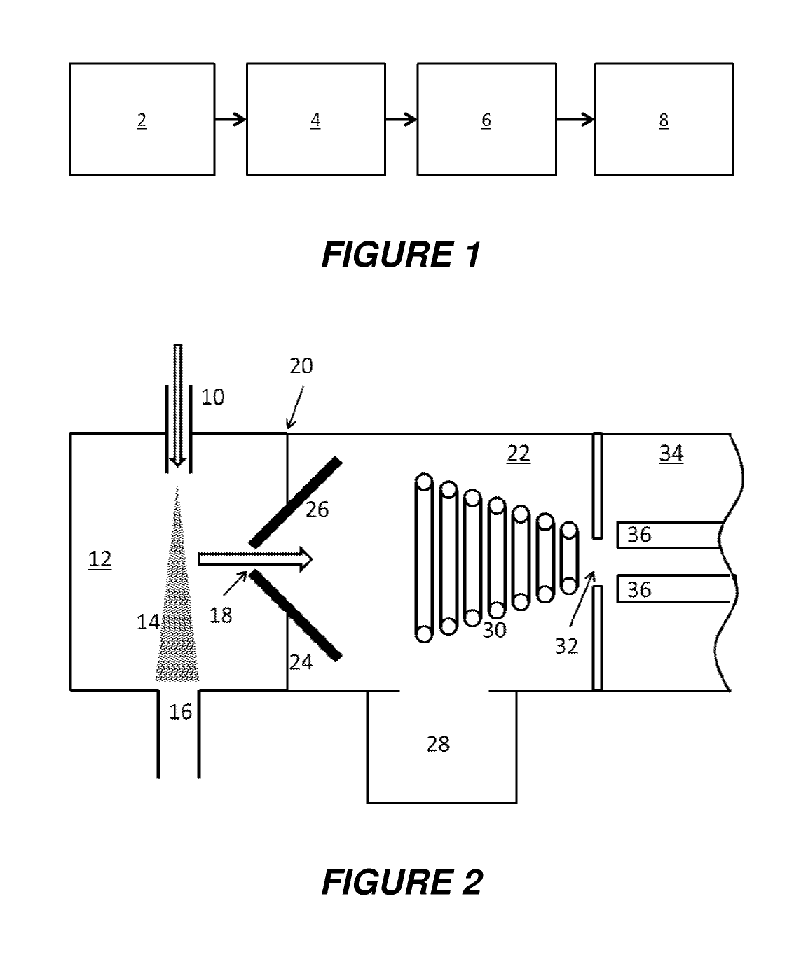

FIG. 1 displays an assembly of four steps (2), (4), (6) and (8) in which an analytical sample contained in a liquid is initially subjected to separation (2), such as in a liquid chromatograph or in an apparatus for capillary electrophoresis (CE). The eluent of the separation device is delivered to an atmospheric pressure ion source (4) where it is nebulized/evaporated and ionized. From the ion source region, the gaseous sample (often accompanied by particulate matter in the form of droplets) is transferred via an interface (6) to a (first) vacuum region of a mass spectrometer (8) where the ions and the remnant gas are further separated. Finally, the ions of interest enter a mass spectrometer (8) and are measured.

A person skilled in the art is aware of current HPLC and CE techniques so that they need not be discussed in further detail here. The same holds true for the different types of mass spectrometer (8) that may be employed in such arrangement. Examples encompass single quadrupole mass analyzers, triple quadrupole mass analyzers, radio frequency (RF) ion traps, time-of-flight mass spectrometers (be it in linear or reflector mode, as the case may be with orthogonal injection), ion cyclotron resonance cells, and so on.

FIG. 2 presents a schematic view of an interface arrangement in a mass spectrometer. In the example displayed, ions are formed at substantially atmospheric pressure by the electrospray process which is well known to a practitioner in the field. A spray probe (10) injects a sample liquid containing solvent and analytes of interest into a spray chamber (12) at substantially atmospheric pressure. Atmospheric pressure in the sense of the present disclosure is intended to mean a pressure of at least about 1000 Pascal, such as actual ambient pressure of the order of 10⁵ Pascal. The spray mist (14) containing mainly gas, (charged or uncharged) droplets and ions is propelled toward an exhaust port (16) through which parts of the spray mist (14) not sampled for the mass spectrometric analysis are vented to exhaust.

FIG. 2 shows a so-called perpendicular arrangement where the gas and ions are sampled in a direction substantially perpendicular to the direction of the spray ejection. This arrangement is however merely exemplary. It is equally possible to align the spray probe (10) in a different direction, for example, such that the spray direction coincides with the axis of the entrance orifice (18) in the interface (20).

The ion source region (12) to the left of FIG. 2 is separated from an adjacent first vacuum region (22) to the right by a divider wall (24), or similar boundary, which is complemented in the shown example by a conical center-piece (26). The first vacuum region (22) is pumped to a pressure preferably half of that in the ion source region (that is, less or substantially less than 55,000 Pascal, but not lower than 50 Pascal, for instance) by a vacuum pump (28) docked thereto. The interface cone (26) is made from a conductive material in order that an electric potential attracting the ions in the ion source region (12) can be applied thereto. The interface cone (26) may act as the counter-electrode to the spray probe (10) in the electrospray process, for instance. The apex of the cone (26) partly penetrates into the ion source region (12) and comprises a central opening (18) which forms a passageway for gas and ions from the ion source region (12) into the first vacuum region (22). In this schematic view, a single central opening (18) is displayed for the sake of simplicity. It is to be understood, however, that a more complex aperture pattern in accord with principles of the present invention can be provided therein and will be explained in further detail below.

In the first vacuum region (22) the wide end of an RF ion funnel (30) is located opposite the wide end of the interface cone (26) from which gas and ions (and droplets as the case may be) emanate. The funnel (30) may consist of a series of ring electrodes having consecutively smaller inner widths (as shown), which are supplied alternately with the different phases of a two-phase RF voltage to radially confine charged particles, such as ions. The neutral gas having passed the interface orifice (18) is not affected by the RF confinement, may flow through the interstitial gaps between the ring electrodes and is finally pumped off. Nonetheless, the pressure inside the first vacuum region (22) is largely defined by the balance between gas flowing in through the orifice (18) from the ion source region (12), the gas pumped off, and a tiny amount of gas that manages to pass through a downstream opening (32) at the other end of the first vacuum region (22) into a second vacuum region (34) held at a pressure lower than in the first vacuum region (22). Ions leaving the narrow end of the RF ion funnel (30) are also transmitted through the downstream opening (32) into the second vacuum region (34) in which an ion manipulation device (36), such as an RF ion guide or a mass analyzer, may be situated.

The electrospray probe (10) has been shown and described in the context of FIG. 2 by way of example only and in a very schematic manner. Practitioners in the field will acknowledge that a wide variety of different embodiments of electrospray probes are at their disposal from which they may choose the most practicable. Implementations may include some that work with additional lateral flows of heated gas in order to increase the desolvation capacity of the liquid spray probe. Further, atmospheric pressure ion sources shall in any case not be limited to those that work with the electrospray principle. It is equally possible to deploy other means for ionizing a liquid sample. One example would be an atmospheric pressure chemical ionization (APCI) source that ionizes gaseous neutral molecules that have been nebulized from a liquid by means of charge transfer reactions with certain reagent ions, as a skilled person well knows.

It is also to be acknowledged that the RF ion funnel (30) comprising a series of ring electrodes is exemplary only. Other suitable embodiments would include funnel arrangements as disclosed, for instance, in U.S. Pat. No. 7,851,752 B2 to Kim et al. and U.S. Pat. No. 8,779,353 B2 to Zanon et al., which are both herewith entirely incorporated by reference into the present disclosure. It may also be conceived to put an ion tunnel or ion guide, having constant inner diameter, in place of the ion funnel as shown in FIG. 2.

Moreover, the interface being conical is just a preferred configuration. In principle, it is also possible to provide for a flat interface in which case the straight wall (24) displayed in FIG. 2 could simply be extended close to the center leaving only slight gap(s) for the orifice(s). The example shown is not to be construed restrictive in this regard.

The above description referring to FIGS. 1 and 2 is intended to convey a picture of the general setting in which an interface in accordance with principles of the present invention may be employed and which is generally known in the art.

In the following, the attempt will be made to further elaborate on the physical principles that govern the processes at an interface between atmospheric or near-atmospheric pressure and sub-atmospheric pressure. However, it has to be borne in mind that this elaboration shall not be seen as binding the claimed invention to any particular theory. The explanations are rather intended to provide some technical guidance to practitioners in the field so that it will be easier for them to grasp the whole scope of the principles of the invention disclosed herein and enable them to reduce these principles to practice.

In an orifice interface between ion source and vacuum region the ion and gas throughput is basically determined by the differential pressure across the orifice and the diameter of the orifice. When the drop in pressure across the orifice is more than a factor of two a free jet expansion occurs behind the orifice in the low pressure region, which means that the ion and gas velocity exceeds the speed of sound and the maximum ion and gas throughput is reached when the pressure reaches about half of the input pressure, which is (near) atmospheric pressure.

When this condition is established the phenomenon of the vena contracta occurs (vena contracta=point in a fluid stream where the diameter of the stream is the least, and fluid velocity is at its maximum; note that Mach 1, about 340 m/s, is not the maximum velocity component in the direction of propagation; during expansion the velocity can reach up to between Mach 25 and Mach 30), meaning that any further increase in pumping speed and consequent decrease in output pressure behind the orifice does not translate into an increased ion and gas throughput. Under this condition of the vena contracta the flow through the orifice is choked. In order to increase the ion and gas throughput yet further, the diameter of the orifice needs to be increased. When the diameter of the orifice is increased the throughput increases. However, in return the desolvation efficiency may decrease to such an extent that no ion signal increase is ultimately obtained.

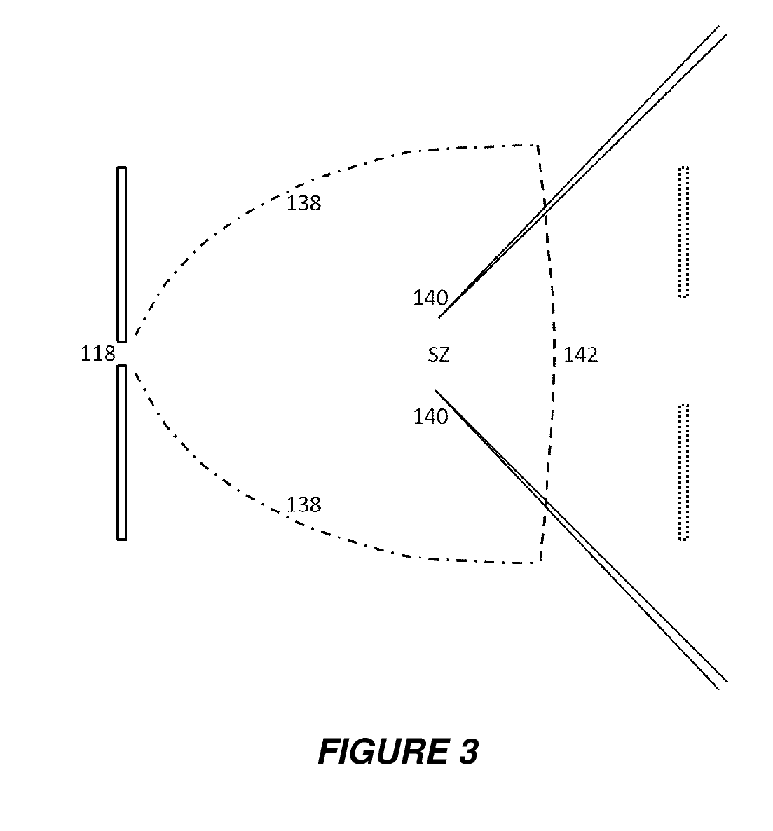

In the past, API interfaces usually sampled ions from the silent zone (SZ) of the free jet expansion (138) behind the orifice (118), as shown in FIG. 3. This condition was accomplished by positioning a cone-like apertured structure or skimmer (140) in the free jet expansion (138). After the introduction of ion funnels for receiving the ions and gas on the low pressure side of the interface, however, it was observed that this condition essential for molecular ion beams was no longer necessary for API interfaces. Instead, the ion and gas plume was expanded within the ion funnel disregarding the position of the Mach disk (142). A conductance limiting element (lens) was positioned downstream of the expansion pass of the Mach disk (142), as shown by the dotted contour on the right of FIG. 3.

This observation suggests that for an inlet interface used with an API source in mass spectrometry the flow regime (laminar or turbulent) of the inlet gas is not so decisive for the operation of the mass spectrometer. Turbulent flow, due to the mixing of the layers, may result in more heat transfer to the core of the ion and gas plume and better desolvation, while laminar flow may result in more friction with the stagnant layers of the flow and consequent reduction in throughput.

As a result of the above considerations, the inventors decided that providing for additional orifices surrounding the common single orifice should result in an increase in the total area through which ions and gas are transmitted from a region at atmospheric pressure to a region at sub-atmospheric pressure, thus raising the throughput of the inlet system according to the increase in conductance and consequently affecting the pressure in the first vacuum region behind the orifice arrangement.

Regardless of this immediate consequence, it was found that the desolvation of droplets upon passing the interface will not be reduced since the lateral orifices maintain substantially the same area but have a small profile for the (gaseous and particulate) matter flowing therethrough. It was anticipated that the flow of ions and gas through the lateral orifices would produce a substantially enveloping layer of gas flow in proximity to the ions and gas that are flowing through the central orifice so that this latter gas flow would not be in contact with stagnant gas which could promote fraying (or friction) of the gas flow and cause loss of usable ions.

It was further anticipated that the jet expansions behind the plurality of orifices would interact advantageously to confine the main barrel shock produced by the central orifice as indicated in FIG. 3, thereby reducing the loss of usable ions from the rim of the central expansion jet while still adding more usable ions through the flow caused by the additional lateral orifices.

The present invention is therefore based on the fact that the throughput of ions through an API interface can be enhanced when a central orifice is surrounded at least section-wise by additional lateral orifices.

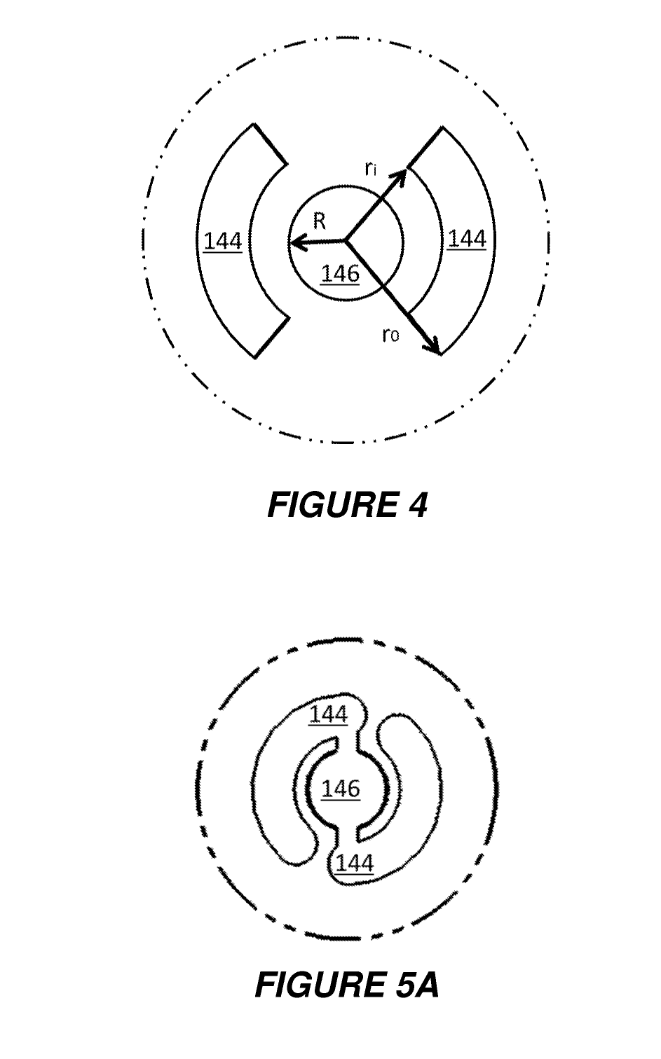

In a first example shown in FIG. 4, in order to increase throughput, two lateral orifices (144) are added to the central orifice (146), wherein the lateral orifices (144) have areas similar to the area of the central orifice and extend around about half the angular circumference of the circular central orifice (146). As is easily ascertained, the conductance of the inlet system thusly configured will be the sum of the conductance of the central orifice (146) plus the two satellite orifices (144), such that the conductance of the inlet system Cₜₒₜₐₗ is equal to Cₜₒₜₐₗ=C_{center}_{_}_{orifice}+2×Cₗₐₜₑᵣₐₗ_{_}_{orifice}

FIG. 4 represents a front view of the suggested exemplary orifice arrangement. It may be implemented in a conical interface (26) as shown in FIG. 2, in which case the lateral orifices (144) would be located in the inclined portion of the cone, but may also work in a flat interface as mentioned before. The orifices (144, 146) connect the atmospheric pressure region (12) of the ion source to the first vacuum region (22) of the mass spectrometer. The orifices (144, 146) are worked into a suitable material, such as metal, that can be heated via a heated desolvation gas flowing in close proximity, for example. The two lateral orifices (144) have substantially the same cross section area and are disposed symmetrically with respect to the central orifice (146) at a pre-determined distance. In FIG. 4, the radius of the central orifice (146) is designated with R; the inner radius of the lateral orifices (144) with rᵢ, and the outer radius of the lateral orifices (144) with rₒ. The distance rᵢ−R defines how far apart the two lateral orifices (144) are located with respect to the central orifice (146). In order to maximize the favorable interaction between the different expansion jets created by the different orifices, the general objective is to make this distance as small as possible, for example as small as the mechanical stability of the conical or divider wall workpiece allows.

Typical values to be considered are R=0.28 mm, rᵢ=0.38 mm, and rₒ=0.68 mm. However, this set of values is not to be construed restrictively. Additional values may be easily verified by experiments accounting, for instance, for the extension of the spray cone emanating from a spray probe, the conductance of the overall inlet system, and the acceptance of a first RF ion guide as receiving element in the first vacuum region, such as an ion funnel as shown in FIG. 2.

In one particular embodiment, the distance rᵢ−R may be minimized in order to overlap the cone extension of the electrospray plume produced by a heated electrospray ionization (HESI) probe in the ion source region.

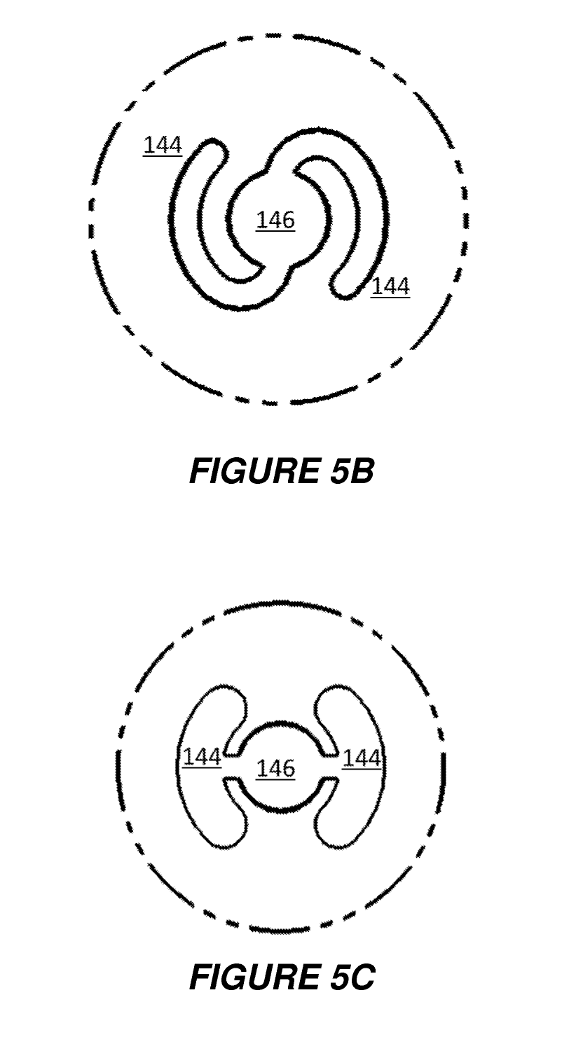

FIGS. 5A to 5C show slight variations of the orifice arrangement from FIG. 4. In these examples, two satellite orifices (144) surround a substantially circular central orifice (146) as in FIG. 4, but are fluidly connected therewith by virtue of small, elongate connections that extend from the central (146) orifice. FIG. 5A, for example, shows two arcuate lateral orifices that extend over a larger portion of the angular circumference than those displayed in FIG. 4. It is also to be considered that the traversable area of the lateral orifices exceeds that of the central orifice in this example, thereby allowing more gas and ions to pass from the ion source region to the vacuum region of the mass spectrometer. In this example, the connections extend substantially radially relative to a curvature of the lateral orifices. FIG. 5B, on the other hand, features narrower lateral orifices which also more smoothly extend from a “mouth” at the central orifice over a large continuous arc surrounding a significant part of the angular circumference of the central orifice which allows the enveloping lateral gas flows on the low pressure side to extend over a larger perimeter. FIG. 5C, in turn, shows shorter and bulkier lateral orifices that are connected to the central orifice at the center of their extension in a radial direction.

Experiments have been carried out by the inventors to verify that the above-described considerations translate into a discernible benefit. To that end, a conical interface resembling the one displayed in FIG. 2 has been set up with an interface cone close to the one shown in FIG. 4 having a central orifice and lateral orifices in accordance with the above-given dimensions (R=0.28 mm, rᵢ=0.38 mm, and rₒ=0.68 mm). In this test setting, an ion-sensitive collecting plate, the electrical current output of which is a measure for the ionic charge received, was positioned on the orifice axis opposite the central orifice in the vacuum region at a distance of about 60 millimeters. The collecting plate had a rectangular receiving surface area of about 18 mm by 18 mm. For comparison purposes, a conical interface having only one central circular aperture (R≈0.28 mm) as it is currently employed in instruments of the so-called EVOQ Elite™ product line of Bruker Daltonics, Inc., Billerica, Mass., was placed in a similar arrangement.

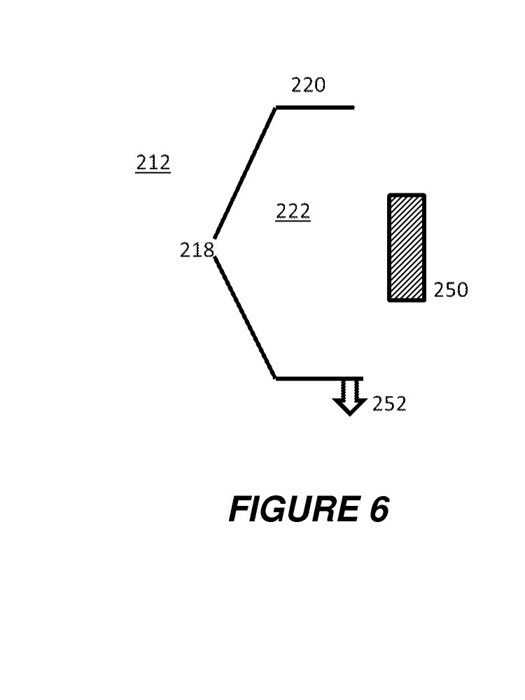

FIG. 6 shows a rough sketch of the experimental setting. The conical interface (220) with central orifice (218) can be clearly seen, with the lateral orifices not being indicated for the sake of clarity. The hatched block (250) represents the collecting plate. The downward pointing arrow (252) stands for the direction in which the gas load in the vacuum region (222) to the right of the interface (220) is pumped off. The ion source to the left of the interface (not shown) was a vacuum insulated probe heated electrospray ion source (VIP-HESI) having a perpendicular alignment that is marketed by Bruker Daltonics, Inc., Billerica, Mass. with the above mentioned EVOQ Elite™ product. The test substance the ions of which were monitored to determine the ion throughput of the interface was tetra-ethyl ammonium chloride that was spiked into a continuous solvent stream to the spray probe at regular intervals at a concentration of about 10 picomol per microliter.

The ion source region (212) was operated at about 10⁵ Pascal. Since the conductance of the interface with the two additional lateral orifices was about three times that of the interface with the single orifice, the pressure on the low pressure side of the interface amounted to a value of about 5×10² Pascal, 3×10² Pascal more than with the interface having merely one orifice. Consequently, the pumping speed had to be adjusted to 110 m³ per hour with the lateral-orifice interface while being slightly lower at 80 m³ per hour for the one-orifice interface. With this simple setting, it was found that while the gas load on the vacuum region (222) to the right of the interface (220) quadrupled with the modified operating conditions, the charge of tetra-ethyl ammonium chloride ions received at the collecting plate (250) consistently increased about sixteen-fold for each spike event resulting in an overall gain of about factor four when compared to the simultaneous change in gas conductance.

Hence, it could be confirmed that providing for additional lateral orifices surrounding the omnipresent central orifice, as shown by way of example in FIG. 4 as well as in FIGS. 5A to 5C, indeed leads to advantageously higher ion throughout which promises to greatly enhance the sensitivity of a mass spectrometer equipped with a corresponding interface configured according to the principles of the invention while not having to take disproportionate increases in gas conductance and concomitant loss of desolvation efficiency.

The invention has been described with reference to a number of embodiments thereof. It will be understood, however, that various aspects or details of the invention may be changed, or various aspects or details of different embodiments may be arbitrarily combined if practicable, without departing from the scope of the invention. Furthermore, the foregoing description is for the purpose of illustration only, and not for the purpose of limiting the invention, which is defined solely by the appended claims.

1. A mass spectrometer having an ion source region at substantially atmospheric pressure in which ions are formed from a liquid sample, and further having an interface for transmitting the formed ions from the ion source region into a vacuum region which is held at a pressure level substantially below the atmospheric pressure and where the formed ions are further processed, wherein the interface comprises a wall dividing the ion source region and the vacuum region and having a central orifice formed therein for letting pass gaseous and particulate matter from the ion source region into the vacuum region following the pressure gradient, the central orifice being surrounded at least section-wise by a plurality of lateral orifices, wherein the central orifice and the lateral orifices are worked directly into a flat wall material so that they comprise narrow lateral edges.

2. The mass spectrometer of claim 1, wherein the central orifice is of substantially circular shape.

3. The mass spectrometer of claim 1, wherein a portion of the wall has a conical shape, the apex of the cone points in the direction of the ion source region, and the central orifice is located at the apex.

4. The mass spectrometer of claim 1, wherein the wall is made of conductive material.

5. The mass spectrometer of claim 4, wherein an electric potential is applied to the wall to attract the ions formed in the ion source region.

6. The mass spectrometer of claim 1, wherein a traversable area of each lateral orifice substantially equals, or is greater than, a traversable area of the central orifice.

7. The mass spectrometer of claim 1, wherein the lateral orifices each have an arcuate, elongate shape.

8. The mass spectrometer of claim 7, wherein a curved contour of the lateral orifices aligns with a curved contour of the central orifice.

9. The mass spectrometer of claim 1, wherein the lateral orifices are interconnected with the central orifice via narrow, elongate openings.

10. The mass spectrometer of claim 1, wherein the plurality of lateral orifices extends over at least half an angular circumference of the central orifice.

11. The mass spectrometer of claim 1, wherein a pressure in the vacuum region is at most half of that in the ion source region.

12. The mass spectrometer of claim 1, wherein an RF ion guide is located in the vacuum region opposite the plurality of orifices to receive a stream of gas and ions emanating therefrom.

13. The mass spectrometer of claim 12, wherein the RF ion guide is an RF ion funnel aligned with its wide end toward the plurality of orifices.

14. The mass spectrometer of claim 1, wherein the ion source region contains a spray source by means of which the liquid sample is nebulized therein and that is aligned such that ions and gas emanating from a spray cone are sampled through the orifices into the vacuum region.

15. The mass spectrometer of claim 14, wherein the spray source is an electrospray probe.

16. The mass spectrometer of claim 14, wherein the spray source receives an eluent of one of a liquid chromatograph and an apparatus for capillary electrophoresis as liquid sample.

17. A mass spectrometer having an ion source region at substantially atmospheric pressure in which ions are formed from a liquid sample, and further having an interface for transmitting the formed ions from the ion source region into a vacuum region which is held at a pressure level substantially below the atmospheric pressure and where the formed ions are further processed, wherein the interface comprises a wall dividing the ion source region and the vacuum region and having an orifice of irregular shape formed therein for letting pass gaseous and particulate matter from the ion source region into the vacuum region following the pressure gradient, the orifice comprising a central portion which is fluidly connected to a plurality of distinct peripheral portions, wherein the orifice is worked directly into a flat wall material so that it comprises narrow lateral edges.

18. The mass spectrometer of claim 17, wherein the fluid connections between the central portion and the plurality of peripheral portions are oriented substantially orthogonally to an extension of the plurality of peripheral portions.

19. The mass spectrometer of claim 17, wherein the fluid connections between the central portion and the plurality of peripheral portions are oriented substantially in line with the plurality of peripheral portions.

20. The mass spectrometer of claim 17, wherein a curved contour of the plurality of peripheral portions aligns with a curved contour of the central portion.

21. The mass spectrometer of claim 4, wherein the conductive material is sheet metal.
